(19) United States
(12) Patent Application Publication
(10) Pub. No.: US 2023/0038034 A1
(43) Pub. Date: Feb. 9, 2023

(54) SYSTEM AND METHOD FOR CLOUD-BASED FAULT CODE DIAGNOSTICS

(71) Applicant: Haier US Appliance Solutions, Inc., Wilmington, DE (US)

(72) Inventor: Wei Zhou, Louisville, KY (US)

(21) Appl. No.: 17/394,912

(22) Filed: Aug. 5, 2021

(51) Int. Cl. G01M 99/00; G06Q 30/00; G06N 20/00

(52) U.S. Cl. CPC G01M 99/005; G06Q 30/012; G06N 20/00

(57) ABSTRACT

A cloud diagnostic system and a method of operating the same to diagnose or predict potential fault conditions in an appliance includes obtaining, at a remote server, a first data stream from the appliance through the external communication network at a first data density (e.g., in megabytes/sec). The method further includes analyzing the first data stream to determine a data anomaly or potential issue exists. The remote server may request that the appliance transmit a second data stream at a second data density that is greater than the first data density and may analyze the second data stream using complex, higher resolution machine learning models to diagnose a potential fault condition for the appliance.

### FIELD OF THE INVENTION

The present subject matter relates generally to consumer or commercial appliances, such as domestic appliances, and more particularly to methods of using cloud-based diagnostics procedures to identify faults in such appliances.

### BACKGROUND OF THE INVENTION

Conventional residential or commercial appliances may be connected to an external network for communicating various data for the purpose of diagnostics, monitoring, or other purposes to improve appliance performance and consumer satisfaction. For example, these cloud-connected appliances may include refrigerator appliances, oven appliances, dishwasher appliances, washing machine appliances, dryer appliances, microwave appliances, air conditioning appliances, etc. Notably, regardless the processes and safeguards in place, operating issues, part failures, maintenance requirements, and other appliance issues may occur during the operation of these appliances, and cloud diagnostics may be a useful tool in diagnosing and addressing these issues.

However, the amount of data harvested from these appliances may be very large, resulting in very high costs for data storage, processing, and analysis. For example, due at least in part to the massive volumes of collected data, data analysis may be processing intensive, inefficient, or even inaccurate. By contrast, it may be difficult to accurately diagnose various conditions if only a subset of data is collected. In addition, obtaining and storing such large amounts of data may present various consumer privacy issues and appliance manufacturers may be subject to negative consumer or public perception if unnecessary or minimally necessary data is collected. Therefore, cloud diagnostic procedures may often be time-consuming, costly, and invasive to consumer privacy.

Accordingly, improved systems and methods for diagnosing fault conditions or monitoring appliance performance are desired. More specifically, systems and methods that utilize diagnostic data efficiently while improving consumer privacy would be particularly advantageous.

### BRIEF DESCRIPTION OF THE INVENTION

Aspects and advantages of the invention will be set forth in part in the following description, or may be obvious from the description, or may be learned through practice of the invention.

In one exemplary embodiment, a method for using a remote server to perform fault diagnostics for an appliance is provided. The appliance includes a controller in operative communication with the remote server through an external communication network. The method includes obtaining, at the remote server, a first data stream from the appliance through the external communication network at a first data density, analyzing the first data stream to identify a data anomaly, obtaining, at the remote server, a second data stream from the appliance through the external communication network at a second data density, the second data density being greater than the first data density, and analyzing the second data stream to diagnose a potential fault condition for the appliance.

In another exemplary embodiment, a method for operating an appliance to facilitate fault diagnostics is provided. The appliance includes a controller in operative communication with a remote server through an external communication network. The method includes transmitting a first data stream from the appliance through the external communication network to the remote server at a first data density, receiving notification of a data anomaly identified in the first data stream, transmitting a second data stream from the appliance through the external communication network to the remote server at a second data density, the second data density being greater than the first data density, and receiving a diagnosis of a potential fault condition for the appliance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a schematic view of a cloud diagnostics system for diagnosing or predicting potential fault conditions in a refrigerator appliance according to exemplary embodiments of the present disclosure.

FIG. 2 provides a method for diagnosing issues with an exemplary appliance using a cloud diagnostics system according to an exemplary embodiment of the present subject matter.

FIG. 3 provides a method for diagnosing issues with an exemplary appliance using a cloud diagnostics system according to an exemplary embodiment of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

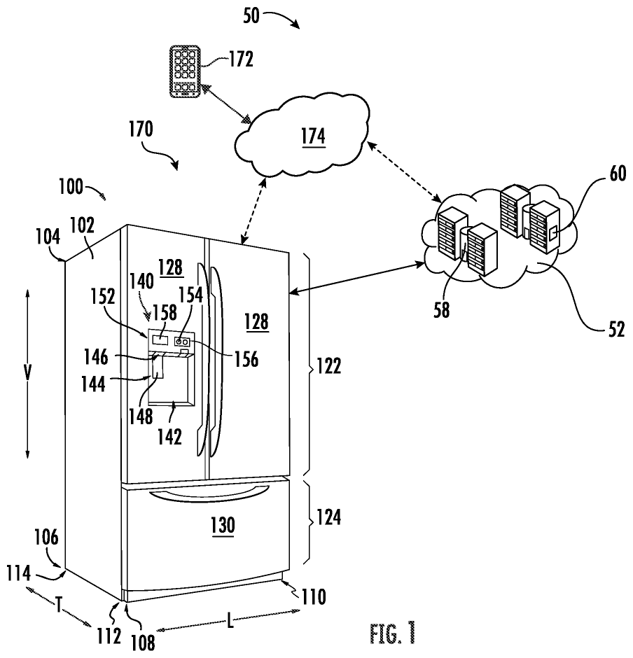

Referring now to the figures, an exemplary cloud diagnostics system 50 will be described in accordance with exemplary aspects of the present subject matter. Specifically, FIG. 1 provides a schematic view of cloud diagnostics system 50 interacting with a single consumer appliance (e.g., illustrated herein as refrigerator appliance 100). Although cloud diagnostics system 50 is illustrated herein as interacting with a single appliance (i.e., refrigerator appliance 100), it should be appreciated that this schematic representation is only intended to facilitate discussion of aspects of the present subject matter. In this regard, for example, cloud diagnostics system 50 and the methods described herein may be used to simultaneously monitor a plurality of appliances located in the same household or in different locations and/or having different owners.

Similarly, although cloud diagnostics system 50 is illustrated herein as interacting with refrigerator appliance 100, it should be appreciated that the sue of this appliance is only intended to facilitate discussion of aspects of the present subject matter. In this regard, for example, although the exemplary appliance is shown as a refrigerator appliance in FIG. 1, it is recognized that the benefits of the present disclosure apply to other types and styles of appliances. For instance, the present disclosure is understood to apply to oven appliances, dishwasher appliances, washing machine appliances, dryer appliances, microwave appliances, air conditioning appliances, etc. Consequently, the description set forth herein is for illustrative purposes only and is not intended to be limiting in any aspect to any particular appliance or configuration.

As will be described in more detail below, cloud diagnostics system 50 may include a cloud diagnostics server 52 that is connected to refrigerator appliance 100 or any other suitable appliance or appliances for performing fault diagnosis or otherwise improving the performance of one or more appliances. Furthermore, cloud diagnostics server 52 may include or may be in operative communication with a historical guidance service (e.g., identified herein generally by reference numeral 58) for communicating appliance data and/or historical data for similar appliances. Although cloud diagnostics server 52 and historical guidance service 58 are illustrated in FIG. 1 as being stored on separate servers that are in communication with each other, it should be appreciated that according to alternative embodiments other system configurations are possible. For example, cloud diagnostics server 52 and historical guidance service 58 may be embodied in or incorporated into a single remote server or even a single model on a server. Each of these parts of cloud diagnostics system 50 will be described below in more detail.

Referring still to FIG. 1, refrigerator appliance 100 will be described in accordance with exemplary embodiments of the present subject matter. For example, refrigerator appliance 100 includes a cabinet 102 that is generally configured for containing and/or supporting various components of refrigerator appliance 100 and which may also define one or more internal chambers or compartments of refrigerator appliance 100. In this regard, as used herein, the terms “cabinet,” “housing,” and the like are generally intended to refer to an outer frame or support structure for refrigerator appliance 100, e.g., including any suitable number, type, and configuration of support structures formed from any suitable materials, such as a system of elongated support members, a plurality of interconnected panels, or some combination thereof. It should be appreciated that cabinet 102 does not necessarily require an enclosure and may simply include open structure supporting various elements of refrigerator appliance 100. By contrast, cabinet 102 may enclose some or all portions of an interior of cabinet 102. It should be appreciated that cabinet 102 may have any suitable size, shape, and configuration while remaining within the scope of the present subject matter.

As illustrated, refrigerator appliance 100 generally defines a vertical direction V, a lateral direction L, and a transverse direction T, each of which is mutually perpendicular, such that an orthogonal coordinate system is generally defined. As illustrated, cabinet 102 generally extends between a top 104 and a bottom 106 along the vertical direction V, between a first side 108 (e.g., the left side when viewed from the front as in FIG. 1) and a second side 110 (e.g., the right side when viewed from the front as in FIG. 1) along the lateral direction L, and between a front 112 and a rear 114 along the transverse direction T. In general, terms such as “left,” “right,” “front,” “rear,” “top,” or “bottom” are used with reference to the perspective of a user accessing appliance 102.

Housing 102 defines chilled chambers for receipt of food items for storage. In particular, housing 102 defines fresh food chamber 122 positioned at or adjacent top 104 of housing 102 and a freezer chamber 124 arranged at or adjacent bottom 106 of housing 102. As such, refrigerator appliance 100 is generally referred to as a bottom mount refrigerator. It is recognized, however, that the benefits of the present disclosure apply to other types and styles of refrigerator appliances such as, e.g., a top mount refrigerator appliance, a side-by-side style refrigerator appliance, or a single door refrigerator appliance. Moreover, aspects of the present subject matter may be applied to other appliances as well. Consequently, the description set forth herein is for illustrative purposes only and is not intended to be limiting in any aspect to any particular appliance or configuration.

Refrigerator doors 128 are rotatably hinged to an edge of housing 102 for selectively accessing fresh food chamber 122. In addition, a freezer door 130 is arranged below refrigerator doors 128 for selectively accessing freezer chamber 124. Freezer door 130 is coupled to a freezer drawer (not shown) slidably mounted within freezer chamber 124. Refrigerator doors 128 and freezer door 130 are shown in the closed configuration in FIG. 1. One skilled in the art will appreciate that other chamber and door configurations are possible and within the scope of the present invention.

Referring again to FIG. 1, a dispensing assembly 140 will be described according to exemplary embodiments of the present subject matter. Although several different exemplary embodiments of dispensing assembly 140 will be illustrated and described, similar reference numerals may be used to refer to similar components and features. Dispensing assembly 140 is generally configured for dispensing liquid water and/or ice. Although an exemplary dispensing assembly 140 is illustrated and described herein, it should be appreciated that variations and modifications may be made to dispensing assembly 140 while remaining within the present subject matter.

Dispensing assembly 140 and its various components may be positioned at least in part within a dispenser recess 142 defined on one of refrigerator doors 128. In this regard, dispenser recess 142 is defined on a front side 112 of refrigerator appliance 100 such that a user may operate dispensing assembly 140 without opening refrigerator door 128. In addition, dispenser recess 142 is positioned at a predetermined elevation convenient for a user to access ice and enabling the user to access ice without the need to bend-over. In the exemplary embodiment, dispenser recess 142 is positioned at a level that approximates the chest level of a user.

Dispensing assembly 140 includes an ice dispenser 144 including a discharging outlet 146 for discharging ice from dispensing assembly 140. An actuating mechanism 148, shown as a paddle, is mounted below discharging outlet 146 for operating ice or water dispenser 144. In alternative exemplary embodiments, any suitable actuating mechanism may be used to operate ice dispenser 144. For example, ice dispenser 144 can include a sensor (such as an ultrasonic sensor) or a button rather than the paddle. Discharging outlet 146 and actuating mechanism 148 are an external part of ice dispenser 144 and are mounted in dispenser recess 142. By contrast, refrigerator door 128 may define an icebox compartment (not shown) housing an icemaker and an ice storage bin (not shown) that are configured to supply ice to dispenser recess 142.

A control panel 152 is provided for controlling the mode of operation. For example, control panel 152 includes one or more selector inputs 154, such as knobs, buttons, touchscreen interfaces, etc., such as a water dispensing button and an ice-dispensing button, for selecting a desired mode of operation such as crushed or non-crushed ice. In addition, inputs 154 may be used to specify a fill volume or method of operating dispensing assembly 140. In this regard, inputs 154 may be in communication with a processing device or controller 156. Signals generated in controller 156 operate refrigerator appliance 100 and dispensing assembly 140 in response to selector inputs 154. Additionally, a display 158, such as an indicator light or a screen, may be provided on control panel 152. Display 158 may be in communication with controller 156, and may display information in response to signals from controller 156.

As used herein, “processing device” or “controller” may refer to one or more microprocessors or semiconductor devices and is not restricted necessarily to a single element. The processing device can be programmed to operate refrigerator appliance 100, dispensing assembly 140 and other components of refrigerator appliance 100. The processing device may include, or be associated with, one or more memory elements (e.g., non-transitory storage media). In some such embodiments, the memory elements include electrically erasable, programmable read only memory (EEPROM). Generally, the memory elements can store information accessible processing device, including instructions that can be executed by processing device. Optionally, the instructions can be software or any set of instructions and/or data that when executed by the processing device, cause the processing device to perform operations.

Referring still to FIG. 1, a schematic diagram of an external communication system 170 will be described according to an exemplary embodiment of the present subject matter. In general, external communication system 170 is configured for permitting interaction, data transfer, and other communications between refrigerator appliance 100 and one or more external devices (e.g., such as portions of cloud diagnostics system 50). For example, this communication may be used to provide and receive operating parameters, user instructions or notifications, performance characteristics, user preferences, fault conditions or data, or any other suitable information for improved performance of refrigerator appliance 100. In addition, it should be appreciated that external communication system 170 may be used to transfer data or other information to improve performance of one or more external devices or appliances and/or improve user interaction with such devices.

For example, external communication system 170 permits controller 156 of refrigerator appliance 100 to communicate with a separate device external to refrigerator appliance 100, referred to generally herein as cloud diagnostics server 52. In addition, external communication system 170 may permit controller 156 of refrigerator appliance 100 to communicate with a remote device 172, such as a personal phone, a smartphone, a tablet, a laptop or personal computer, a wearable device, a smart home system, or another mobile or remote device.

As described in more detail below, these communications may be facilitated using a wired or wireless connection, such as via a network 174. In general, cloud diagnostics server 52 may be any suitable device separate from refrigerator appliance 100 that is configured to provide and/or receive communications, information, data, or commands from a user. In this regard, cloud diagnostics server 52 may be, for example, a cloud-based server located at a distant location, such as in a separate state, country, etc. According to an exemplary embodiment, appliance 100 may communicate with cloud diagnostics server 52 over network 174, such as the Internet, to transmit/receive data or information, provide user inputs, receive user notifications or instructions, interact with or control refrigerator appliance 100, etc. According to exemplary embodiments, cloud diagnostics server 52 may be configured to receive appliance data and diagnose or predict potential fault conditions, as will be described in more detail below.

In general, communication between refrigerator appliance 100, cloud diagnostics server 52, and/or other user devices or appliances may be carried using any type of wired or wireless connection and using any suitable type of communication network, non-limiting examples of which are provided below. For example, cloud diagnostics server 52 may be in direct or indirect communication with refrigerator appliance 100 through any suitable wired or wireless communication connections or interfaces, such as network 174. For example, network 174 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 170 is described herein according to an exemplary embodiment of the present subject matter. However, it should be appreciated that the exemplary functions and configurations of external communication system 170 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

Now that the construction and configuration of cloud diagnostics system 50 and refrigerator appliance 100 have been presented according to an exemplary embodiment of the present subject matter, an exemplary method 200 for using a remote server to perform fault diagnostics for an appliance is provided. Method 200 can be used to operate cloud diagnostics system 50 and refrigerator appliance 100, or to operate any other suitable appliance and diagnostic system. In this regard, for example, controller 156 and/or a controller remotely positioned within cloud diagnostics system 50 may be configured for implementing method 200. However, it should be appreciated that the exemplary method 200 is discussed herein only to describe exemplary aspects of the present subject matter and is not intended to be limiting.

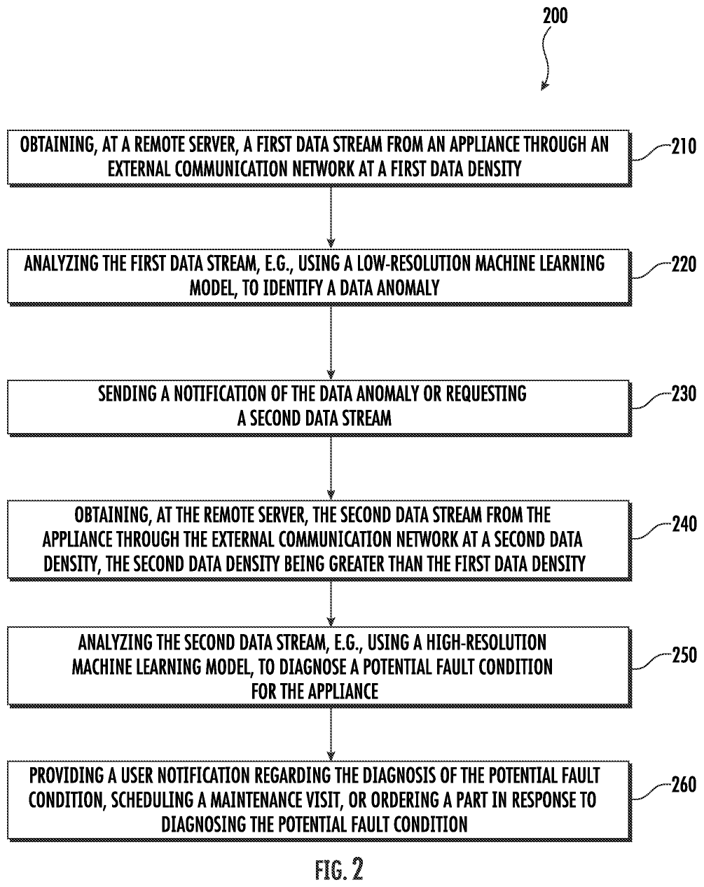

As shown in FIG. 2, method 200 may generally include connecting an appliance (or a plurality of appliances) to a cloud diagnostics server over a network such that data from the appliance(s) is transmittable to the cloud diagnostics server. For example, continuing the example from above, refrigerator appliance 100 may be connected to cloud diagnostics system 50, e.g., via cloud diagnostics server 52. It should be appreciated that refrigerator appliance 100 (or any other suitable appliances) may be connected to cloud diagnostics server in any manner suitable for facilitating data transmission therebetween. As described below, method 200 may generally be performed by cloud diagnostics server 52 or another remote server.

For example, according to the illustrated embodiment, the step of connecting refrigerator appliance 100 to cloud diagnostics server 52 (as shown in solid lines) may include connecting a refrigerator appliance 100 to cloud diagnostics server 52 such that appliance data from refrigerator appliance 100 is transmittable to cloud diagnostics server 52, e.g., to transfer various appliance data, such as operational or performance data, fault codes or indications, or other event occurrence data. In general, a controller of the appliance, such as controller 156 of refrigerator appliance 100, may be programmed to periodically transmit appliance data to cloud diagnostics server 52. In addition, or alternatively, controller 156 may transmit data at specified time intervals or when certain conditions occur that indicate service may be needed or a fault may be present. It should be appreciated that the communication of appliance data from refrigerator appliance 100 to cloud diagnostics server 52 may be achieved in any other suitable manner while remaining within the scope of the present subject matter.

Referring now specifically to FIG. 2, step 210 may include obtaining, at a remote server, a first data stream from an appliance through the external communication network at a first data density. For example, continuing the example from above, refrigerator appliance 100 may send a stream of first data to cloud diagnostics server 52 through external communication interface 170, e.g., to facilitate diagnostics or otherwise improve appliance performance, as described in more detail below.

Notably, as explained briefly above, refrigerator appliance 100 and other appliances that are connected to a cloud diagnostics system may generate large amounts of data during normal operation. Receipt, storage, and analysis of such data such large volumes may be very inefficient, expensive, and computationally difficult. Accordingly, aspects of the present subject matter are directed to methods for reducing the burden of data storage and analysis at a remote server while minimizing the effects of bandwidth limitations common at consumers' households and improving consumer privacy.

In this regard, the appliance data transmitted from refrigerator appliance 100 to cloud diagnostics server 52 may be any data or information that may be suitable for assessing appliance performance or potential fault conditions. In this regard, for example, the appliance data may include at least one of appliance identification data, manufacturing information, and operational data related to potential fault conditions. According to exemplary embodiments, the manufacturing information may include at least one of a model number, a product line, the manufacturing date, the manufacturing location, a unique session identification, a batch number, etc. In addition, the manufacturing information may include important system information such as at least one of a list of appliance components or supplier identification for one or more appliance components. Furthermore, the transmitted appliance data may include event logs, operating history, internal diagnostic results, etc.

As described in more detail below, cloud diagnostics system 50 may use all this information to identify fault clusters, trends, or repeatable issues that arise with respect to one or more appliances, assemblies used in such appliances, components or subcomponents, or parts of such appliances. These issues or potential fault conditions may be traced to specific parts, appliance manufacturers, assembly dates, manufacturing dates, materials used, etc. Moreover, this information may be used to more accurately predict and identify potential issues with the performance of one or more appliances (e.g., other than refrigerator appliance 100) interacting with cloud diagnostics system 50.

Referring again to FIG. 2, step 220 may generally include analyzing the first data stream to identify a data anomaly. In this regard, cloud diagnostics server may analyze the first data stream to detect a data anomaly that might correspond to or be indicative of issues related to appliance operation, maintenance problems, or other issues that may be addressed to improve appliance performance. According to exemplary embodiments, step 220 of analyzing the first data stream may use a machine learning model on the cloud diagnostics server to diagnose or predict potential fault conditions or identify data anomalies. In general, the appliance data received at step 210 may be input into the machine learning model, which may be designed and configured to identify data anomalies and generate potential fault conditions for the purposes of fault diagnosis.

Exemplary machine learning models will be described below according to exemplary embodiments. However, it should be appreciated that any suitable model may be used to analyze the data received at step 220 (or step 240), and the present subject matter is not intended to be limited to the specific models described herein unless indicated otherwise. In addition, it should be appreciated that the machine learning models may include supervised and/or unsupervised models and methods. In this regard, for example, supervised machine learning methods (e.g., such as targeted machine learning) may help identify problems, anomalies, or other occurrences which have been identified and trained into the model. By contrast, unsupervised machine learning methods may be used to detect clusters of potential failures, similarities among data, event patterns, abnormal concentrations of a phenomenon, etc.

As explained briefly above, cloud diagnostic server 52 can be used to host a service platform, a cloud-based application, and/or an information database (e.g., a machine-learned model, a series of machine learning models, received data, or other relevant service data—optionally including intermediate processing data products). Cloud diagnostic server 52 and other portions of cloud diagnostic system 50 can be regulated or implemented using any suitable computing device(s). In this regard, each server generally includes a controller (e.g., similar to controller 156) having one or more processors and one or more memory devices (i.e., memory). The one or more processors can be any suitable processing device (e.g., a processor core, a microprocessor, a CPU, an ASIC, a FPGA, a microcontroller, etc.) and can be one processor or a plurality of processors that are operatively connected. The memory device can include one or more non-transitory computer-readable storage mediums, such as RAM, DRAM, ROM, EEPROM, EPROM, flash memory devices, magnetic disks, etc., or combinations thereof. The memory devices can store data and instructions (e.g., on-transitory programming instructions) that are executed by the processors to cause the remote server to perform operations. For example, instructions could be instructions for receiving/transmitting component signals (e.g., including data or information), appliance data or performance metrics, fault codes or conditions, analyzation results, machine-learned models, etc.

In some embodiments, cloud diagnostics server 52 can store or include one or more machine-learned models (e.g., as identified generally by reference numeral 60). As examples, the machine-learned model(s) 60 can be or can otherwise include various machine-learned models such as, for example, neural networks (e.g., deep neural networks, etc.), support vector machines, decision trees, ensemble models, k-nearest neighbors models, Bayesian networks, logistics models, gradiant boost models, XGBoost models, or other types of models including linear models or non-linear models. Example neural networks include feed-forward neural networks (e.g., convolutional neural networks, etc.), recurrent neural networks (e.g., long short-term memory recurrent neural networks, etc.), or other forms of neural networks.

The machine-learned models of the cloud diagnostics server 52 may be used to analyze the appliance data transmitted from the refrigerator appliance 100. Additionally or alternatively, cloud diagnostics server 52 can train the machine-learned models through use of a model trainer (e.g., training algorithm), as would be understood. For example, as explained above, these models may include supervised models (e.g., trained or targeted toward certain problems or occurrences) and/or unsupervised models and methods (e.g., used to detect clusters of data similarities). Optionally, such a model trainer may train machine-learned models based on a set of training data compiled from a plurality of different appliances, appliance models, etc.

Cloud diagnostic server 52 may include a network interface to facilitate communication over one or more networks (e.g., network 174) with one or more network nodes. Network interface can be an onboard component or it can be a separate, off board component. In turn, cloud diagnostics server 52 can exchange data with one or more nodes over the network 174. Furthermore, it is understood that cloud diagnostic server 52 may further exchange data with any number of client devices over a network such as network 174. The client devices (e.g., such as remote device 172) can be any suitable type of computing device, such as a general purpose computer, special purpose computer, laptop, desktop, integrated circuit, mobile device, smartphone, tablet, or another suitable computing device. Information, signals, or other data (e.g., relating to appliance performance, fault conditions, analyzation results, inputs/outputs of machine-learned models, etc.) may thus be exchanged between refrigerator appliance 100 and various separate client devices (e.g., directly to the user or maintenance technicians) through cloud diagnostic server 52.

In the event that a data anomaly is identified at step 220, step 230 may include sending notification of the data anomaly to the appliance, e.g., to refrigerator appliance 100. In addition, or alternatively, step 230 may include requesting a second data stream from the appliance for further analysis. Upon transmittal of the second data stream, step 240 may include obtaining, at the remote server, the second data stream from the appliance through the external communication network at a second data density. In other words, once a data anomaly is identified by the low-resolution data, cloud diagnostics server 52 may request and/or receive high-resolution data from the appliance for analysis.

In this regard, as explained above, the first data stream may be transmitted to the cloud diagnostics server 52 at a first data density while the second data stream may be transmitted at a second data density. According to exemplary embodiments of the present subject matter, the second data density is greater than the first data density. In this manner, as explained herein, the relatively more intensive data analysis of the second stream of data (e.g., the higher resolution data) may be performed only in the event that the data analysis of the first data stream (e.g., the lower resolution data) identifies a data anomaly of concern. By contrast, method 200 may further include analyzing the first data stream and determining that the data appears normal (e.g., that no data anomaly exists), and in response, continuing to obtain the first data stream from the appliance at the first data density.

As used herein, the terms “data density” and the like are generally intended to refer to the amount or size of data transmitted from an appliance to a remote server over a particular time period. For example, according to an exemplary embodiment, the data density may correspond to an average data transfer rate, e.g., measured in megabytes per second. For example, the first data density may be fixed at a predetermined number of megabytes per second and the second data density may be greater than 2 times, 3 times, 5 times, 10 times, or 100 times the predetermined number of megabytes per second. Notably, the data densities as described herein are only exemplary and are not intended to limit the scope of the present subject matter in any manner. Moreover, it should be appreciated that the data density transmitted from refrigerator appliance 100 may be adjusted or manipulated in any suitable manner.

For example, the data density transmitted from refrigerator appliance 100 may depend on the frequency of data transmission, the amount of data transmitted at each data sample, and/or the number of sensors or data streams measured by refrigerator appliance 100 that are transferred as a data sample. For example, according to exemplary embodiments, the first data density may include data samples obtained at no less than once every 5 seconds, every 15 seconds, every 30 seconds, every minute, every 5 minutes, or greater. By contrast, the second data density may include data samples obtained at no greater than once every 5 seconds, every 3 seconds, every 2 seconds, everyone second, every 0.5 seconds, every 0.1 seconds, or lower.

According to still other embodiments, refrigerator appliance 100 may include a plurality of sensors or other data streams that can be transmitted to cloud diagnostics server 52 for analysis. According to exemplary embodiments, adjusting the data density (e.g., from the first data density to the second data density) may include adjusting a sample frequency of only a subset of the plurality of sensors. In this regard, for example, certain sensors may maintain the transmission rate of data between the first data stream and the second data stream, whereas other sensors may adjust their rates of data transmission or terminate the transmission altogether, thus resulting in an overall change in data density.

In addition, the transmission of appliance data may be scheduled or regulated to minimize user inconvenience or conflict with the operation of refrigerator appliance 100 or with an accompanying network (e.g., such as network 174). For example, it may be undesirable to transmit large amounts of data and affect the operational capacity at controller 156 during the performance of one or more operating cycles of refrigerator appliance 100. In addition, the bandwidth required to transfer these data streams may bog down or slow home consumer networks (e.g., network 174). Accordingly, the first data stream and the second data stream may be stored on controller 156 until a desirable time arises for data transmission, such as when refrigerator appliance 100 is not being used or network traffic is very low.

Referring again to FIG. 2, step 250 may include analyzing the second data stream to diagnose a potential fault condition for the appliance. In this regard, with the benefit of the higher resolution data, cloud diagnostics server 52 may more accurately identify potential fault conditions and take appropriate corrective action (e.g., as described in more detail below). Similar to step 220, step 250 may include the implementation of one or more machine learning models. More specifically, according to an exemplary embodiment, cloud diagnostics server 52 may implement higher resolution machine learning models to analyze the second stream of data at the second data density (i.e., higher resolution relative to the low resolution machine learning models that might be used to analyze the first stream of data).

Notably, once a potential fault condition is diagnosed, method 200 may include implementing corrective action. For example, step 260 may include providing a user notification regarding the diagnosis of the potential fault condition, e.g., via control panel 12 or through a remote device 172 (e.g., via network 174). In this manner, a user may be made aware of potential issues, may interact with refrigerator appliance 100 to correct potential issues, etc. In addition, or alternatively, method 200 may include flagging a component of the appliance for repair, service, or replacement when the machine learning model detects an anomaly or diagnoses a potential fault in the appliance data. In this regard, for example, if compressor failure is imminent, method 200 may include prompting the user to schedule a service visit or order a replacement part (or may automatically implement such actions). It should be appreciated that other responsive actions may be implemented in response to the identification, prediction, or diagnosis of potential fault conditions.

Although method 200 is described as transmitting and/or receiving data streams at a first data density and a second data density, it should be appreciated that aspects of the present subject matter may be used to facilitate the transmission and/or analysis of any suitable number of data streams, transmitted at any suitable times, and at any suitable data densities. For example, certain data anomalies identified at step 220 may merit a third data stream at an even higher data density than the second data density (e.g., where data samples may be collected from all sensors at no greater than once every one second). Alternatively, a third data stream may be requested by an appliance owner or by a maintenance technician for routine appliance inspection. Accordingly, method 200 may include identifying such a high-resolution data trigger, obtaining a third data stream from the appliance at a third data density, and analyzing the third data stream to diagnose potential fault conditions to the appliance or identify some other issue.

According to exemplary embodiments, method 200 may further include regulating the transmission, receipt, storage, and analysis of high-resolution data to those appliances that pay for such a service. In this regard, for example, method 200 may include determining that the appliance does not have an active warranty contract and obtaining a payment from an appliance owner prior to requesting and/or receiving the second data stream. By contrast, method 200 may include determining that the appliance does have an active warranty contract and automatically receiving and analyzing the second data stream.

In addition, although aspects of the present subject matter are described above as being used to monitor refrigerator appliance 100, it should be appreciated that refrigerator appliance 100 may be one of a plurality of monitored appliance that are all connected to cloud diagnostics server 52 for monitoring and diagnostic analysis. Accordingly, cloud diagnostics server 52 may generally maintain a list of all connected appliances and may monitor each of those appliances. Cloud diagnostic server 52 may further maintain an attention list of all appliances for which a data anomaly was identified in a respective first stream of data and/or another fault list for which the potential fault condition was identified from the respective second stream of data.

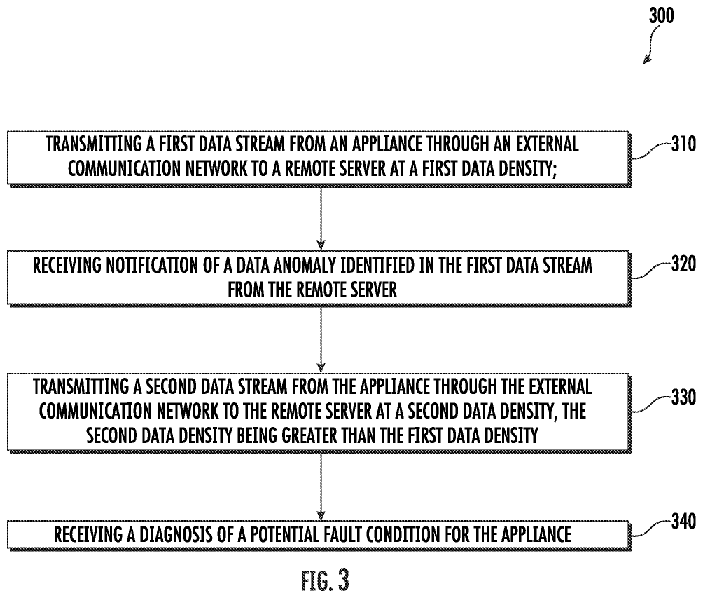

Referring now briefly to FIG. 3, the interaction between one or more appliances with a cloud diagnostic server, e.g., refrigerator appliance 100 with cloud diagnostics server 52, will be described from the perspective of the appliance. It should be appreciated that the steps in method 300 may be the same or similar to steps performed in method 200. Accordingly, these steps will not be described in detail for brevity. In this regard, method 300 may include, at step 310, transmitting a first data stream from an appliance through an external communication network to a remote server at a first data density. For example, refrigerator appliance 100 may be preprogrammed to connect to cloud diagnostics server 52 and periodically transmit low resolution data to cloud diagnostics server 52 for analysis.

Step 320 may include receiving notification of the data anomaly identified in the first data stream from the remote server. In this regard, cloud diagnostics server 52 may monitor the first data stream transmitted by refrigerator appliance 100 and may identify when a data anomaly exists. In addition, or alternatively, method 300 may further include a step wherein an application programming interface (API) on the cloud (e.g., cloud diagnostic server 52) commissions the appliance to schedule the transmission of a second (or additional) stream of data at a second data density when a fault or data anomaly is detected. Step 330 may include transmitting a second data stream from the appliance through the external communication network to the remote server at a second data density, the second data density being greater than the first data density. Step 340 may include receiving a diagnosis of the potential fault condition for the appliance from the remote server. In this regard, cloud diagnostic server 52 may analyze the second stream of data using one or more machine learning models to identify the presence of potential fault conditions and may communicate the potential fault conditions to the appliance or the appliance owner.

FIGS. 2 and 3 depict exemplary control methods having steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of these methods are explained using cloud diagnostics system 50 and refrigerator appliance 100 as an example, it should be appreciated that these methods may be applied to the operation of any suitable appliance and/or diagnostic system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for using a remote server to perform fault diagnostics for an appliance, the appliance comprising a controller in operative communication with the remote server through an external communication network, the method comprising:
obtaining, at the remote server, a first data stream from the appliance through the external communication network at a first data density;
analyzing the first data stream to identify a data anomaly;
obtaining, at the remote server, a second data stream from the appliance through the external communication network at a second data density, the second data density being greater than the first data density; and
analyzing the second data stream to diagnose a potential fault condition for the appliance.

2. The method of claim 1, further comprising:
analyzing the first data stream to determine that no data anomaly exists; and
continuing to obtain the first data stream from the appliance at the first data density.

3. The method of claim 1, wherein the first data density comprises data samples at no less than once every 15 seconds, and wherein the second data density comprises data samples at no greater than once every 5 seconds.

4. The method of claim 1, wherein the first data density is a predetermined number of megabytes per second, and wherein the second data density is greater than three times the predetermined number of megabytes per second.

5. The method of claim 1, wherein the appliance comprises a plurality of sensors that transmit data to the remote server, wherein obtaining the second data stream at the second data density greater than the first data density comprises:
adjusting a sample frequency of only a subset of the plurality of sensors.

6. The method of claim 1, further comprising:
identifying a low usage time for the appliance from the first data stream; and
obtaining the second data stream during the low usage time.

7. The method of claim 1, further comprising:
determining that the appliance does not have an active warranty contract; and
obtaining payment from an appliance owner prior to obtaining the second data stream.

8. The method of claim 1, further comprising:
identifying a high-resolution data trigger;
obtaining a third data stream from the appliance through the external communication network at a third data density, the third data density being greater than the second data density; and
analyze the third data stream to diagnose the potential fault condition for the appliance.

9. The method of claim 8, wherein the third data density comprises data samples at no greater than once every 1 second.

10. The method of claim 1, wherein the appliance is one of a plurality of monitored appliances that are in operative communication with the remote server, the method further comprising:
maintaining an attention list of appliances from the plurality of monitored appliances that are identified as having potential fault conditions.

11. The method of claim 1, wherein at least one of analyzing the first data stream or analyzing the second data stream comprises using a machine learning model.

12. The method of claim 11, wherein the machine learning model comprises at least one of a convolution neural network (“CNN”) model, a logistics model, a gradiant boost model, an XGBoost model, or a neural network.

13. The method of claim 1, wherein analyzing the first data stream comprises using a low-resolution model and analyzing the second data stream comprises using a high-resolution model.

14. The method of claim 1, further comprising:
providing a user notification regarding the diagnosis of the potential fault condition.

15. The method of claim 14, wherein the appliance comprises a user interface panel and the user notification is provided through the user interface panel.

16. The method of claim 14, wherein the controller is in operative communication with a remote device through the external communication network, and wherein the user notification is provided through the remote device.

17. The method of claim 1, further comprising:
sending a notification of the data anomaly to the appliance or requesting the second data stream.

18. The method of claim 1, further comprising:
scheduling a maintenance visit or ordering a part in response to diagnosing the potential fault condition.

19. The method of claim 1, wherein the appliance is an oven appliance, a refrigerator appliance, a dryer appliance, a microwave appliance, or a heat pump water heater appliance.

20. A method for operating an appliance to facilitate fault diagnostics, the appliance comprising a controller in operative communication with a remote server through an external communication network, the method comprising:
transmitting a first data stream from the appliance through the external communication network to the remote server at a first data density;
receiving notification of a data anomaly identified in the first data stream;
transmitting a second data stream from the appliance through the external communication network to the remote server at a second data density, the second data density being greater than the first data density; and
receiving a diagnosis of a potential fault condition for the appliance.
